(19) United States
(12) Patent Application Publication
(10) Pub. No.: US 2020/0099706 A1
(43) Pub. Date: Mar. 26, 2020

(54) MULTI-LAYER APPROACH TO MONITOR CELL PHONE USAGE IN RESTRICTED AREAS

(71) Applicant: INTERNATIONAL BUSINESS MACHINES CORPORATION, ARMONK, NY (US)

(72) Inventors: Wiliam P. Righi, Porto Alegra (BR); Niemeyer Souza Barbosa, Hortolandia (BR); Tiago Dias Generoso, HORTOLANDIA (BR)

(21) Appl. No.: 16/136,864

(22) Filed: Sep. 20, 2018

(51) Int. Cl. H04L 29/06; H04W 4/021; H04L 29/08; G06F 11/34; G06N 5/04

(52) U.S. Cl. CPC H04L 63/1425; H04W 4/021; G06N 5/046; G06F 11/3438; H04L 67/22

(57) ABSTRACT

A system and method are provided for managing mobile device in a restricted area, which includes determining a length of time the mobile device remains in a predetermined area. The method includes incrementing a threat level by a first amount, wherein the first amount is calculated using a predictive model created with historical information derived from a management system. The method includes comparing usage of the mobile device with one or more existing models that describe a behavior of a regular user and a suspect user. The method includes incrementing the threat level by a second amount when usage matches a particular behavior. The method includes using a set of cognitive techniques to further assess potential behavior of a user. In response to determining the threat level associated with the mobile device exceeds a fourth threshold, the method includes initiating a predefined action.

### TECHNICAL FIELD

The present invention relates generally to a computer-based method and system for intercepting, controlling, monitoring, recording and reporting wireless communications in a controlled environment in order to take preventative action against illicit behavior.

### BACKGROUND OF THE INVENTION

Correctional facilities confines and denies a variety of freedoms as a form of punishment to criminals, but it has also become a haven for inmates to organize new crimes through hidden communication devices (like cell phones). The systems to prevent use of these devices in restricted areas are weak and vulnerable. The inmates have easy access to devices that enables them to communicate with outsiders facilitating crime.

### SUMMARY OF THE INVENTION

The present invention provides a system and method are provided for managing mobile device in a restricted area. The method includes operations for determining a length of time the mobile device remains in a predetermined area in response to determining that the mobile device entered the area. In response to determining the length of time exceeds a first predetermined threshold, the method includes incrementing a threat level associated with the mobile device by a first predetermined amount, wherein the predetermined amount is calculated using a predictive model created with historical information derived from a management system for a telecom network. In response to determining the threat level associated with the mobile device exceeds a second predetermined threshold, the method includes comparing usage of the mobile device with one or more existing models that describe a behavior of a regular user and the behavior of a suspect user. In response to determining the usage of the mobile device matches a behavior associated with an existing criminal model, the method includes incrementing the threat level associated with the mobile device by a second predetermined amount. In response to determining the threat level associated with the mobile device exceeds a third predetermined threshold, the method includes using a set of cognitive techniques to further assess potential behavior of a user. In response to determining an analysis of data collected from the usage of the mobile device is indicative of a potential attempt to commit a predetermined negative action, the method includes incrementing the threat level associated with the mobile device by a third predetermined amount. In response to determining the threat level associated with the mobile device exceeds a fourth predetermined threshold, the method includes initiating a predefined action intended to prevent said predetermined negative action.

### BRIEF DESCRIPTION OF THE DRAWINGS

A further understanding of the present invention can be obtained by reference to the preferred embodiments set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 shows an overall view of a simple preferred embodiment of the present invention comprising the major components of an apparatus according to the present invention.

FIG. 2 is a schematic representation of the interaction of different features of the invention as they relate to the central phone surveillance system according to an embodiment of the present invention.

FIG. 3 illustrates a schematic representation of the interaction of the call data records to the analytics and cognitive systems in order to report effective information to the proper authorities according to an embodiment of the present invention.

FIG. 4 is a flow chart showing the multi-layered method to identify improper use of cell phones in restricted areas according to an embodiment of the present invention.

FIG. 5 is a relationship tree and flow diagram for the method of generating regular and suspect individual profiles according to an embodiment of the present invention.

FIG. 6 is a flow chart illustrating a continuous learning method for enhancing the model of analyzing call patterns and data to provide a suitable solution for each data situation according to an embodiment of the present invention.

FIG. 7 depicts a block diagram of components of a computing device, in accordance with an illustrative embodiment of the present invention.

FIG. 8 depicts a cloud computing environment, according to an embodiment of the present invention.

FIG. 9 depicts abstraction model layers, according to an embodiment of the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Generally, the need to control access to outside telephone lines in a secured institutional environment is well recognized, especially where highly confidential information is being handled. In order to prevent individuals from incurring large, unaccountable telephone costs which the institution ultimately bears, one must either restrict access to outside telephone lines or institute accounting controls whereby the costs of unauthorized calls can be billed to the responsible individuals. The solutions proposed by the telecommunication companies is to install signal blockers, but such solutions are not as effective as expected leaving communication gaps.

Telephone systems in security-clearance-only environments require additional security considerations. Without appropriate controls on telephone access, employee have been known to use the telephones to transmit confidential information to outside parties. Therefore, it is critically important for security management officials to carefully plan, control, monitor and record some restricted employee's access to outside telephone lines.

One of the more recent problems with the effectiveness of secure telephone systems is the use of wireless communication. While electronic micro technology is facilitating a significant reduction in the size of cellular phones, other technologies are increasing their area transmission capabilities in response to increased market demand. With the reduced size, cell phones can be smuggled into secure facilities or be otherwise made available to restricted personnel to transmit and receive information outside the facility in which they are working or being detained and bypass the normal method of controlled communication via the landline inmate telephone control system. It is anticipated that because restricted personnel are aware that conversations over the landline systems are controlled, routinely monitored, and recorded by security officials, that a transmission taking place over a wireless network would typically involve a conversation that the subject person did not want the security officials to be aware of.

The preferred embodiment(s) will be described with reference to restricted work-area wireless call management and security. This, however, should not be viewed as limiting, since the invention is also applicable in other institutional settings such as courtrooms, military bases, schools, mental institutions and business organizations. Likewise, the invention is applicable to the interception of a wide variety of wireless transmissions, such as amateur (ham) radio or cb radio signals.

The purpose of this disclosure is a method and system to identify and prevent crimes made from inside restricted areas (like high security work area or courtrooms). The solution applies high end analytical techniques to identify suspicious behaviors, building patterns and profiles based on usage activities gathered from telecommunication's network.

The method proposes a surveillance system for communication devices (cell phones) in restricted areas like high-security-level work areas. The method is based on threat levels or levels of alerts and a ranking system, which adds points to each device in the restricted areas, herein in referred as “red zones” (prisons and suspicious areas), that match pre-established behaviors. A ranking system is used as a filter to reduce the amount of cases to be further analyzed by the system in next or subsequent threat levels. As the suspicious devices accumulate points, these will eventually go higher in the ranking system reaching the next alert or threat levels, which will implement more sophisticated techniques to analyze the device behavior. The valuation set forth herein using points is intended as one example to explain the features of this invention, but the invention is not intended to be limited to a “points” system. Rather, any type of evaluation technique may be used to accomplish the purpose and intent of this invention.

The main advantage of this method is the efficient use of resources to analyze a large number of devices in the most effective manner. The method starts with simple analysis that may be performed with a large set of data and as the devices accumulate points, advanced techniques are applied to identify devices that are potentially being used by criminals or for criminal activity.

The solution proposed may be used in conjunction with analysis of data from any known telecommunications network system to verify location and usage behavior. The method is not based on the installation of any additional apparatus to perform signal jamming, in which many of the existing solutions are based. But, signal jamming or blocking may be incorporated into this invention. In addition, the solution presented herein is more cost-effective than other solutions as it will make use of existing data gathered from existing systems. Moreover, the invention will make use of techniques ranging from geo-location, internet data usage and speech to text analysis to down-select phone users that has reached higher position in ranking system which are potentially making use of phones inside restricted areas. In other words, the solution will not use advanced techniques for investigating all active cell phone devices, thus resulting in cost savings and reducing the need of a high processing infrastructure.

In light of the above, one object of the invention is a method of managing wireless telephone activity in an institutional environment to achieve improved security and call control. Another object of the invention is a system adapted to perform such institutional wireless telephone management.

Yet another object of the invention is a method and apparatus for passively monitoring and/or recording a wireless telephone connection to detect security breaches without violating any laws protecting the privacy of a caller.

A further object of the invention is an institutional wireless telephone management system wherein the parameters that control the operation of the system as well as the records of system activity are stored in a central database, thereby permitting simple customization of system operation, generation of reports and monitoring of status.

In addition, other features of the wireless communications control system provide various security and monitoring functions. For example, the invention provides different degrees of monitoring, any or all of which may be active for a given call. The first degree is “live” call (voice) monitoring, where the security personnel may actively listen to a live call. The second degree is call recording. The system can be programmed to enable associated recording equipment to record telephone calls for later monitoring. The third degree is “passive” line monitoring, where the system detects, for example, multiple NPA/NXX/XXXX signals, DTMF tones, off-hook conditions, voltage spikes and/or sudden line impedance changes, in order to track attempts at unauthorized three-way calling, call conferencing, call transferring, call forwarding or re-dialing via various alternate common carriers, many of whom now offer “1-800” or local telephone number (e.g., “950”) access numbers.

In accordance with an embodiment of the invention, all calls are passively monitored and, once a particular risk level has been reached, noted calls are recorded. At any time, security officials can selectively invoke live monitoring to listen in on any call in progress. System alarms, which trigger any time a subject person places a call or calls a certain person, allow officials to determine when live call monitoring is appropriate. Likewise, the telephone system of the present invention can be programmed to default in any manner.

It is noted that the present invention is focused on cellphone calls; however, the techniques set forth herein may be applied to land-line calls or other transmissions whether transmitted through appropriate institutional communications systems or through hidden or concealed cell phones.

In addition, the invention may include biometric voice verification features. The system, for example, may digitize a sample of the caller's voice. The system then compares the digitized sample with a stored voice print, to verify the identity of the caller. Also, such biometric monitoring may be used to automatically determine the authorized/unauthorized status of the caller. This could be achieved by comparing the live or recording biometric sample with a pre-approved list/database of voices for the particular wireless signal intercepted. Such biometric monitoring may also be used in a passive call monitoring mode, wherein the system takes periodic samples of the parties' voices and checks against a database of voice prints, in order to capture and monitor records of unauthorized callers who may be participating in a call, either via phone sharing or via third party calling.

The principal feature of the present invention is the implementation of a way to detect, monitor, record and control restricted personnel or other regulated caller's wireless telephone calls or other wireless transmissions to outside parties; to prevent unauthorized receipt by subject persons of wireless telephone calls or other wireless transmissions; and to detect, trace, and prevent unauthorized wireless telephone calls whereby said called parties act to bridge the restricted person or regulated caller to some third party.

Broadly, the present invention takes the form of an apparatus and method for intercepting the transmission of wireless communication signals in order to provide wireless communications control and management in an institutional environment.

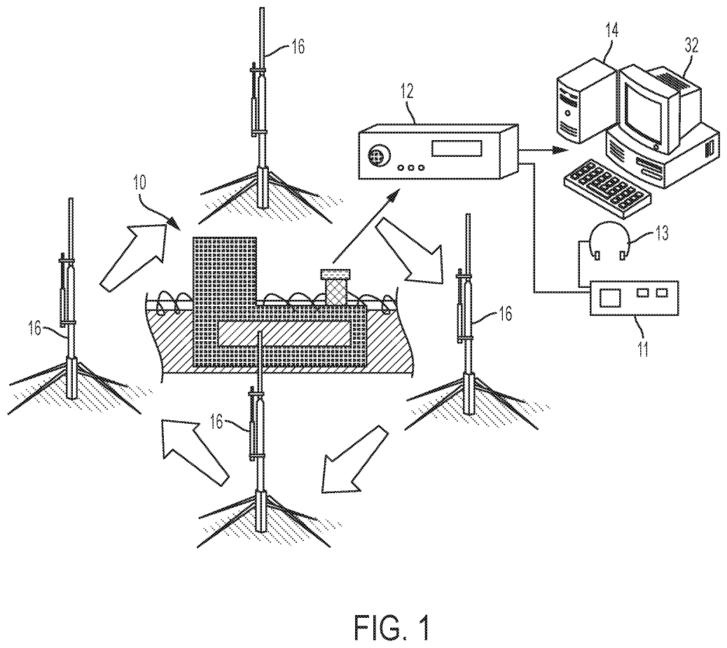

FIG. 1 represents a simple embodiment of the above, incorporating reception, interpretation, monitoring, recording, and controlling wireless signals. In FIG. 1, a wireless communications management system according to the present invention detects wireless transmissions to or from any of a plurality of wireless telephones within an institution 10. As shown, a preferred apparatus of the present invention comprises a microprocessor-based control unit 14 (MCU), a scanner/receiver 12, and at least one reception antennae 16 (four shown in FIG. 1). Optionally, the system of this invention can be integrated with an existing institution call control system to provide a fully integrated call management system within an institution 10.

In operation of the preferred embodiment of the present invention, when a cellular mobile radiotelephone originates a call, it transmits a series of data messages to the local base station. These data messages always contain (1) the low order seven digits of the unit's telephone number, known as the Mobile Identification Number (MIN); (2) the unit's Station Class Mark (SCM), which identifies functional characteristics of the unit; and (3) the Called Address, or dialed telephone number. The MIN2 (the high order three digits or NPA of the cellular unit's telephone number), and the Electronic Serial Number (ESN) are typically also transmitted.

When this wireless transmission is made in the vicinity of the institution, the transmitted signal is received by reception antennae 16 and routed to the scanner/receiver 12, where the transmitting frequency is identified and isolated, and the signal demodulated. The scanner/receiver 12 identifies the signal's NPA/NXX/ESN or other identifying data and passes the data to the MCU 15; alternatively, the MCU 15 can itself identify the signal's identifying data based upon the received signal. The MCU 15 then compares the data against a list of preauthorized wireless transmission signals.

In some embodiment of the present invention, calls may be jammed, blocked or otherwise impacted by the operators of the system. For example, if the signal's NPA/NXX/ESN is found to be authorized, no further action is taken and the call is permitted to continue without further monitoring. If, on the other hand, the signal is unauthorized, the MCU 14 may jam the transmission, notify an administrator of the unauthorized transmission, etc., and the call may be monitored and recorded via the monitor/record station 13. However, the specific treatment and resolution of such call will be described in more detail below.

A preferred apparatus of this invention interfaces MCU 14, scanner/receiver 12, one or more administrative terminals 32, and reception antennae 16. If the system components are collocated, a data/communications/control bus would serve to interconnect them. Otherwise, a LAN/WAN network, perhaps including dedicated digital data/telephone line services, could be used. The preferred structure would accommodate data transfers, digitized voice signals, call processing data, and the like. In addition to the real-time detection capabilities, the apparatus will enable a full range of reports detailing call detail characteristics and other detectable parameters which can serve as data comparison with other available investigative databases.

Optionally, scanner/receiver 12 can provide digitized voice samples in order to record messages (such as the person's name) and to support biometric voice verification or monitoring functions. Scanner/receiver 12 (or other comparable apparatus) could be configured to provide digitized voice samples, for example, for each call made, whereby such samples are sufficient in length to provide verification that the person indeed participated in a conversation with a particular called party on a particular date and at a particular time and on a particular cellular telephone. Thus, if a person or a called party subsequently claims that a particular telephone communication never occurred, the security administrator can retrieve the voice verification record to evaluate whether claims that certain calls were never made are in fact false.

The objective of this disclosure is to describe a method of surveillance for suspect use of cell phones in restricted areas, such as use of cell phones by employees in secret-clearance areas. Information produced by this method may be used to alert the authorities regarding suspect use of phones to commit crimes. The method uses multiple factors starting with simple analysis like geo-location of cell phones to advanced techniques like voice recognition and speech to text technologies.

This disclosure presents a multi-layer and cost-effective method to detect suspect cell phone usage in restricted areas, allowing authorities to take preventive actions against crimes. The method makes use of a wide range of techniques and technologies such as geo-location, speech to text and voice recognition in order to identify suspicious behavior within large number of users in a cost-effective manner and is capable of being tuned based on previous decisions (continuous learning).

The method supports continuous learning/improving based on evaluation of previous decisions taken, false positives or new input data, such as data from new coverage areas. This is an important feature for security and/or surveillance systems as “offensive” users may quickly change their behavior when the system detects their intent.

In addition, this method provides a cost-effective way to monitor a large user base, as the initial coverage area may be limited to areas of interest (e.g., secure work environments). At initial levels of suspect, simple and cheap monitoring methods are employed, like simple geo-location of cell users. Complex and costly methods are applied only to highly suspect users, minimizing the chances of false-alerts and the resources spent on them.

In order to focus the disclosure of the solution, increasing effectiveness and reducing costs, this method is more focused on restricted areas (but not limited to) such as restricted work environments, high-security areas, schools, neighborhoods and so on. These areas will be called here by “red zones” and will be monitored by the phone surveillance system using the disclosed method. Any other antenna which coverage area does not include phone restricted locations may be excluded from the system, reducing the area and user base to be monitored.

For example, workers in a highly secure work environment may smuggle cell phones into the secure areas to make calls, access internet, send SMS, etc. Usually these calls are likely to make unwarranted calls, pass confidential information to outsiders, etc.

All use of cell phones (voice call, Internet activity, and text messages) originating in the red zone(s) are captured and forwarded to an analytic system. The data includes call records (CDRs), SMS and internet activity, and lower level events like connections and disconnections of devices on the telecommunication network. This stream of data is collected directly from network devices and forwarded to an analytical system. This analytical system will employ a multi-layered method to rank the user in suspect levels.

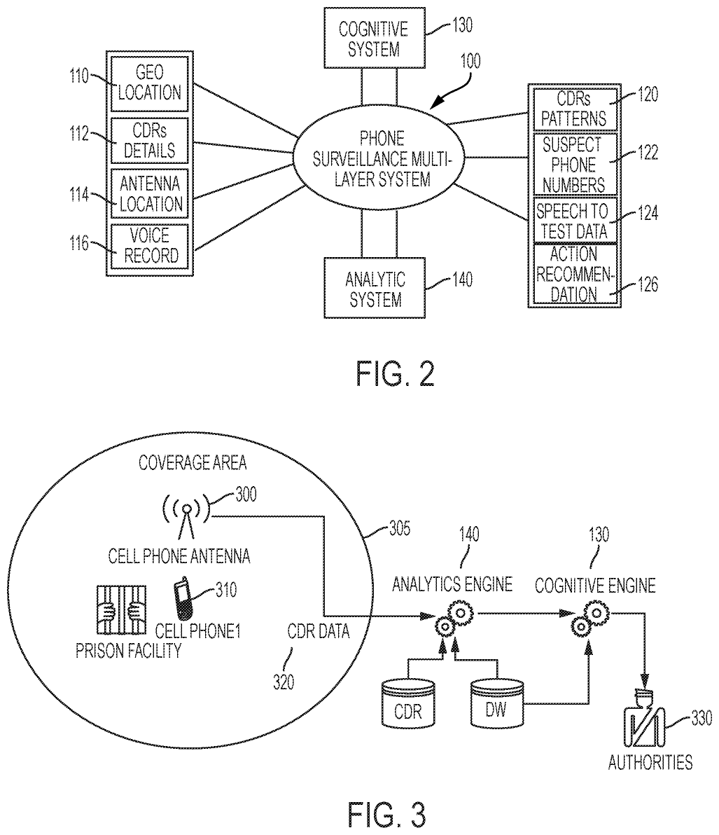

FIG. 2 is a schematic representation of the interaction of different features of the invention as they relate to the central phone surveillance system according to an embodiment of the present invention. With reference to FIG. 2, the phone surveillance system is a collective interaction of the computer-based system 100 which collects data related to geo location 110, call record detail 112, antenna location 114, and voice records 116. The system 100 further accesses and retrieves data related to call record patterns 120, target phone numbers 122, speech-to-text data 124, and action recommendations 126 (system solutions based on past solutions as described below). The system 100 utilized both cognitive systems 130 and analytic systems 140 to analyze collected data and make predictions about potential future actions based on historical data and recordings. For example, the analytics system 140 may analyze the cell phone user's behavior; e.g., call patterns, SMS messages, Internet usage, etc., and attempt to match the analyzed behavior with patterns developed in the system using historical data. With regard to the cognitive system 130, advanced techniques such as speech to text data to assess and analyze criminal intent; i.e., intent is inferred and predicted from the collected data.

In a preferred embodiment, the system will be composed of components like a stream processing unit (SPU), which is responsible for receiving the stream of information from the network devices and process the data in real time. In order to supply additional information to the SPU, the system maintains data repositories that contains enhanced information about cell phone users, suspect behavior models and SPU work data (temporary data space).

FIG. 3 illustrates a schematic representation of the interaction of the call data records to the analytics and cognitive systems in order to report effective information to the proper authorities according to an embodiment of the present invention. With reference to FIG. 3, CDR data 320 is collected at the antenna 300 from the cell phone 310 and delivered to the analytics engine 140 and cognitive engine 130. The area of coverage for the antenna 300 is termed the “restricted area” or “red zone” 305. The resulting determinations and analysis is then delivered to the appropriate authorities 330 who will be changed with taking appropriate action depending on the data analysis.

At the lower levels of suspicious, the analytic system uses simple methods to match the user of the cell phone with known patterns. At this level, methods may include (but not limited to): geo-location mobility patterns (e.g. the cell phone do not leave the red zone), patterns of connection and disconnection of the device in the network (i.e. turning cell phone on and off), mobility of the user across the network, etc.

As the user behavior matches these known suspicious patterns, points are accumulated, and the user will eventually be moved to a higher threat level or alert level. At higher threat levels, the monitoring of the cell phone is performed by advanced systems employing cognitive techniques used to further describe the use of the cell phone. These techniques may include recording of the calls followed by a speech-to-text translation. The text is than analyzed by cognitive systems searching for patterns that may characterize criminal behavior. It is noted that, in certain states, territories, countries due to legislation regulations, previous consent and authorizations may be required prior to recording.

Having used advanced techniques to assure the use of cell phone is suspect, the system may either take defined actions, such as dropping the call or record and track the destination numbers called by the suspect; and also notify authorities that possible crime is taking place by the user of given cell phone.

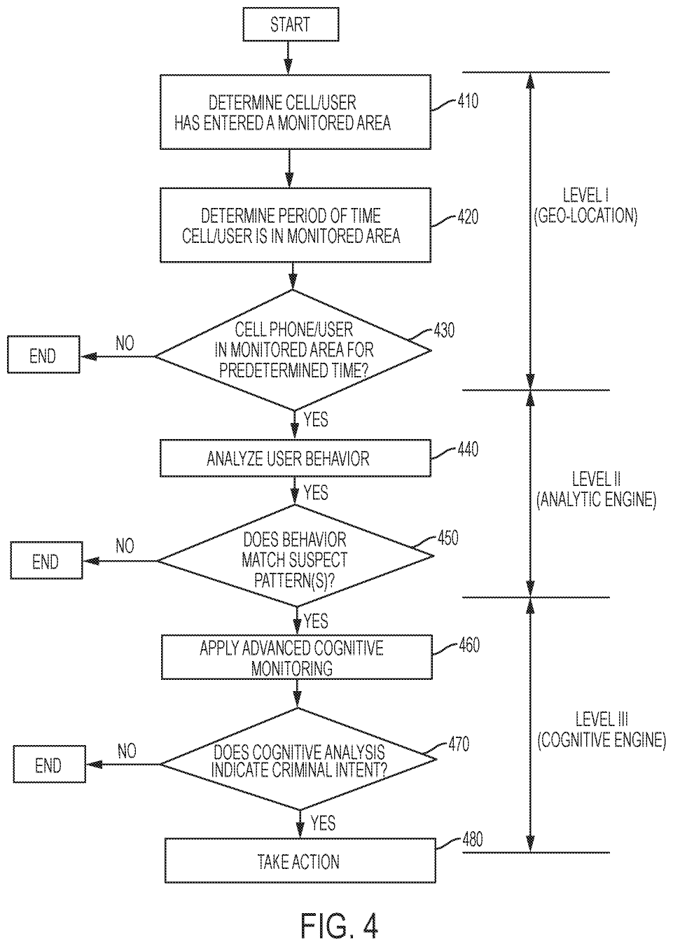

FIG. 4 is a flow chart showing the multi-layered method to identify improper use of cell phones in restricted areas according to an embodiment of the present invention. The benefit of this disclosure is the method to evaluate the cell phone users and identify improper use in restricted areas. With reference to FIG. 4, the multi-level method will be described, including the triggers and what is accomplished in each phase. The method starts and then begins recording data at step 410 when a cell phone enters the restricted area, i.e., the red zone, shown as zone 305 in FIG. 3. The triggering event is a device that is connected to and transmitting data to/from the telecom network via one of the antennas covering the red zones.

At the initial level, the method will focus on the user's geo-location. In the initial phase at step 420, the system will measure for how long the user (i.e., cell phone 310) stays in the red zone 305. It's expected that regular (non-suspect) users will eventually leave the red zone(s) 305 in a reasonable amount of time (hours or days). As the user stays in the monitored area for longer periods of time than expected, the interest on this user increases at step 430. The interest or level of scrutiny is calculated in the form of accumulating points that will eventually elevate the user to the next monitoring level. The period of time to be considered a suspect (or the amount of points to accumulate) will be defined by predictive models created with past information from telecom network. This period of time and threat level; e.g.., amount of points, will be recalculated regularly to calibrate the system as new data is processed.

At level 2 determined at step 440, the cell phone usage will be compared with existing models that describe both regular and suspect user behaviors by the analytic engine 140. The models contain attributes like average number of calls, distinct destination numbers, call duration, geographic information of target numbers, among others. Again, the models will be initially created based on historical information from telecom systems (e.g. historical CDR information, customer base, known fraudulent users, etc.). As the system analyses and produces more data, the models are recreated, assuring that they are up to date and the system continuously learn from user's behaviors.

As the monitored cell phone behavior matches with the existing restricted or criminal models, additional points are accumulated by the user at step 450. Eventually, the system through the point-calculation method (or other suitable measurement system) will elevate the user to the next monitoring level 3 which utilizes cognitive analysis (cognitive engine 130) to assess behavior and predict future behavior. At level 3 (step 460), the system implements cognitive techniques to describe even further the behavior of the cell phone user. These cognitive techniques use to consume more resources and be more costly, so the method provides the benefit of only applying such advanced algorithms to users who are potentially committing crimes, reducing the costs of false alerts. The techniques applied at this level may include (but not limited to): recording of the calls, voice recognition, speech-to-text transformation of the calls, sentiment analysis on the text to identify criminal or malicious intent, analysis of the content being transmitted via internet and SMS, etc.

As cognitive system 130 analyzes transcripts, data is collected from phone utilization and the system evaluates whether the analyzed behavior is or maybe an attempt to commit prohibited acts (e.g., stealing company secrets), contact accomplices or any other illegal action. In the process, additional points are accumulated by the users as indicative of a higher threat level. By accumulating sufficient points, the system confirms at step 470 with high level of confidence the illegal intent of the cell phone user and may take a set of predefined actions at step 480.

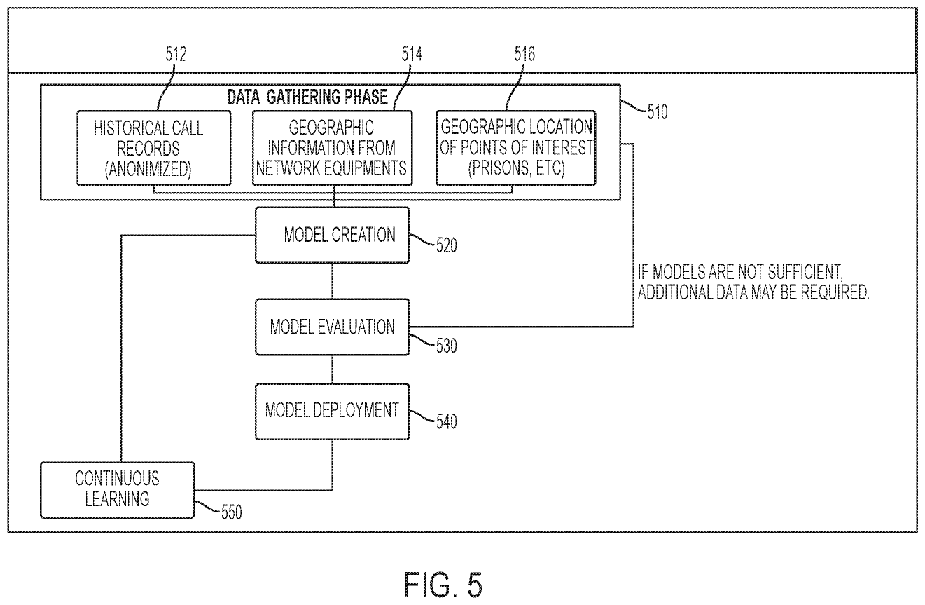

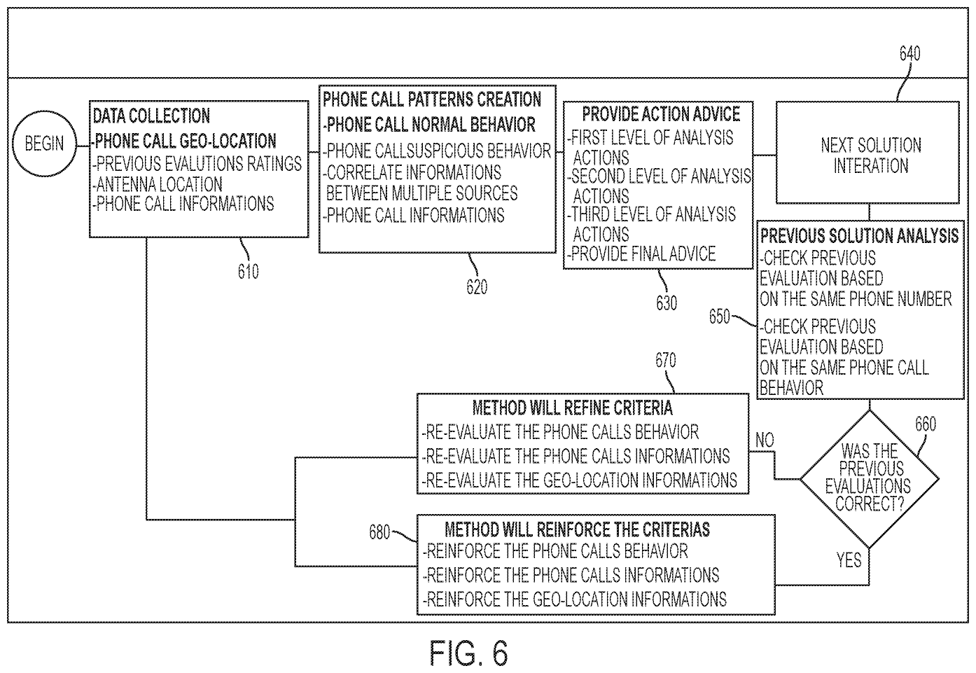

As the system identifies a user as an inmate making use of a cell phone in secure environments, the system may take predefined action, such as alerting the authorities, blocking the cell phone, etc. FIG. 5 is a relationship tree and flow diagram for the method of generating regular and suspect individual profiles according to an embodiment of the present invention. At the data gathering phase 510, all the data required to analyze and create the models are obtained. This data includes: historical call records 512, which may be anonymous, including calls made from red zones 305; geographic location of network equipment 514, like antennas and other devices; geographic location of surveillance areas 516, like secure work areas and other suspicious areas of interest. At the model creation phase 520, all the data gathered is prepared, enhanced, and analyzed by data mining and/or machine learning algorithms to produce predictive models. This may include techniques like supervised and non-supervised algorithms that describe what regular cell phone users behave and also how suspicious users behave. At the model evaluation phase 530, models created in the previous phase are tested and evaluated against a test data set. The objective of this phase is to measure the model accuracy, as well as minimize potential false alerts generated by the model. At the model deployment phase 540, the model is deployed for use by the application monitoring the network in real time. The continuous learning phase 550 (see FIG. 6) is used to enhance the operation of the system for analyzing all calls described herein.

FIG. 6 is a flow chart illustrating a continuous learning method for enhancing the model of analyzing call patterns and data to provide a suitable solution for each data situation according to an embodiment of the present invention. In the continuous learning phase 550, the execution of the model in production will generate additional information that will be used to produce improved models. All failures and success cases of the model will be gathered in used as input to a new iteration of the model creation phase, aiming to enhance the model. The continuous learning phase 550 begins with data collection at step 610 related to phone call geo-location; e.g., previous evaluation ratings, antenna locations, phone call data, etc. At step 620, the system generates a phone call pattern profile, including normal call behavior, suspicious call behavior, correlation between multiple data sources, call data, etc. At step 630, the system generates action advice based on first level analysis actions, second level analysis actions, and third level analysis actions compiled in the historical data.

When a solution has been generated and provided to the appropriate authorities at step 640, the system will analyze previous actions used on the same phone number at step 650, and at step 660 the system will determine whether the previous evaluation was, in fact, accurate based on data input from the relevant authorities. Whether the action recommendation was correct or incorrect, the system will refine the criteria related to call data, behavior, and geo information at steps 670 and 680 in order to update the data provide to the data collection step 610 and in order to refine the analysis process conducted by both the analytic engine 140 and the cognitive engine 130.To create the models discussed and described above, one preferred embodiment utilizes a cloud-based data analysis system in conjunction with a unified analytics engine for large scale data processing which systems are known to those of skill in the art. To process the incoming flow of data from network devices, those of skill in the art may utilize advanced computing platforms that allow users-developed applications to receive, analyze and correlate information as it arrives from thousands of real-time sources. For level 3 analysis, one of skill in the art may use a system (API) that analyze text and understand a wide variety of characteristics, including sentiment, entity, emotion, keyword, concept tagging, language and taxonomy, as well as speech to-text conversion, voice recognition, among others. To generate the reports, one embodiment utilizes analytics report systems and ETL (Extract, Transform and Load) systems. To collect the required information, big data analytics systems can be utilized, which are known to those of skill in the art. To analyze the collected information, one of skill in the art would utilize cognitive and analytics systems known in the art. On the continuous learning mechanism, one preferred embodiment utilizes predictive systems that collect and analyze structured and unstructured content in documents, emails, databases, websites and other enterprise repositories. By providing a platform for crawling and importing content, parsing and analyzing content, and creating a searchable index, these systems help perform text analytics across all data in an enterprise. These systems and method to enable the present invention are set forth by way of example only and are not intended to limit the scope and protection of the invention. They are set forth as a means of guidance only to those of skill in the art.

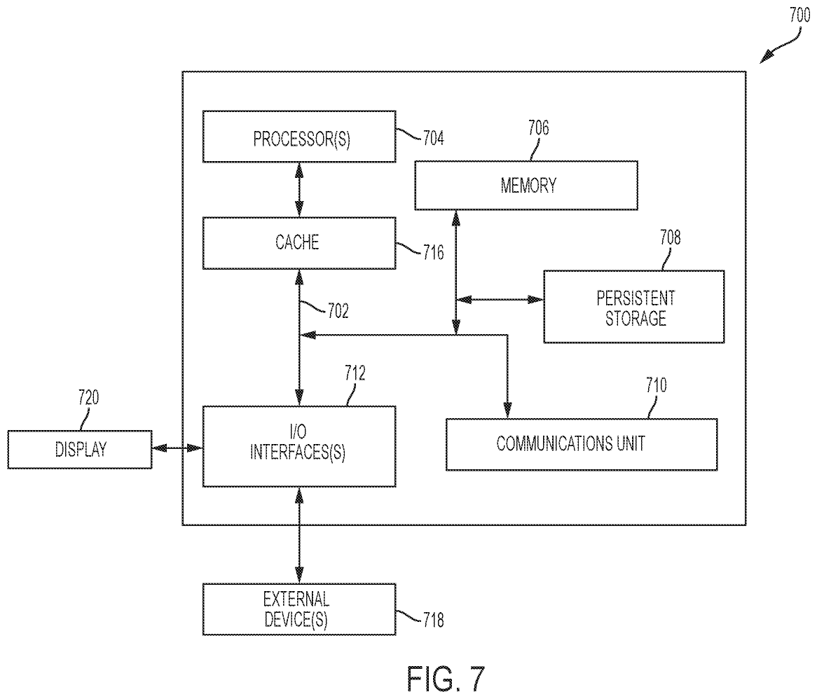

FIG. 7 depicts a block diagram of internal and external components of a computing device, generally designated 700, which is representative of components of computer 14 of FIG. 1, in accordance with an embodiment of the present invention. It should be appreciated that FIG. 7 provides only an illustration of one implementation and does not imply any limitations with regard to the environment in which different embodiments may be implemented. Many modifications to the depicted environment may be made.

Computing device 700 includes communications fabric 702, which provides communications between computer processor(s) 704, memory 706, cache 716, persistent storage 708, communications unit 710, and input/output (I/O) interface(s) 712.

Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM). In general, memory 706 can include any suitable volatile or non-volatile computer readable storage media. Cache 716 is a fast memory that enhances the performance of processors 704 by holding recently accessed data, and data near recently accessed data, from memory 706.

Program instructions and data used to practice embodiments of the present invention may be stored in persistent storage 708 and in memory 706 for execution by one or more of the respective processors 704 via cache 716. In an embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices, including resources of a network. In these examples, communications unit 710 includes one or more network interface cards. Communications unit 710 may provide communications through the use of either or both physical and wireless communications links. Program instructions and data used to practice embodiments of the present invention may be downloaded to persistent storage 708 through communications unit 710. I/O interface(s) 712 allows for input and output of data with other devices that may be connected to computing device 700. For example, I/O interface 712 may provide a connection to external devices 718 such as a keyboard, keypad, a touch screen, and/or some other suitable input device. External devices 718 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 708 via I/O interface(s) 712. I/O interface(s) 712 also connect to a display 720.

Display 720 provides a mechanism to display data to a user and may be, for example, a computer monitor, or a television screen.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

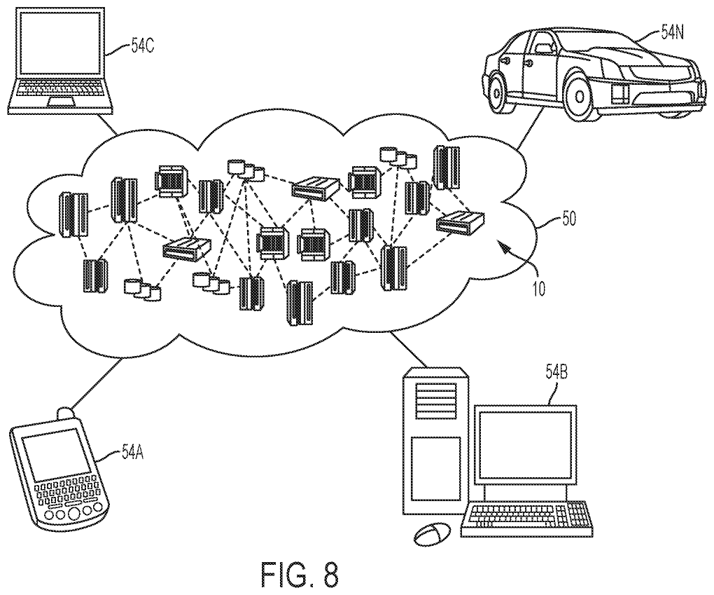

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

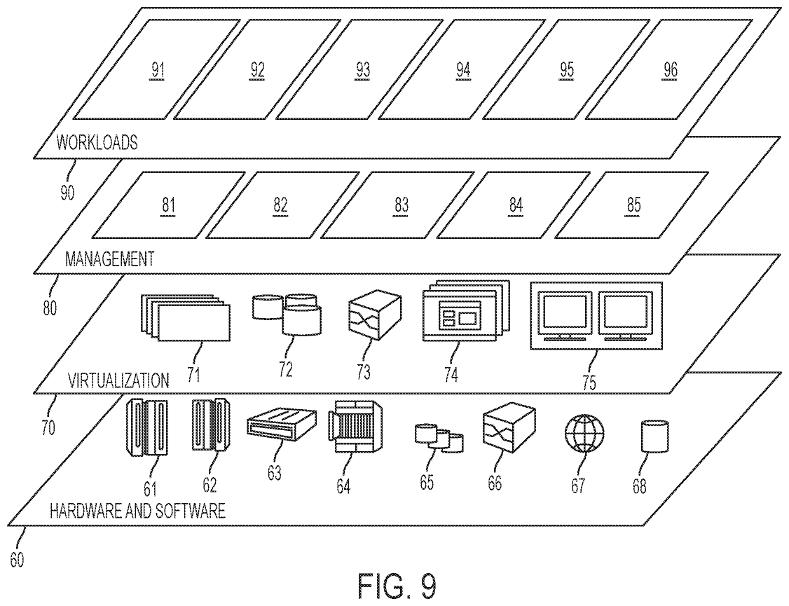

Referring now to FIG. 9, a set of functional abstraction layers provided by cloud computing environment 50 (FIG. 7) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software module(s) 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method comprising:
in response to determining a mobile device has entered a predetermined area comprising a geo-location, determining, by one or more processors, a length of time the mobile device remains in the predetermined area;
in response to determining the length of time exceeds a first predetermined threshold, incrementing, by one or more processors, a threat level associated with the mobile device by a first predetermined amount, wherein the first predetermined threshold is calculated using a predictive model created with historical information derived from a management system for a telecom network, said predictive model associating said length of time with a threat indication;
in response to determining the threat level associated with the mobile device exceeds a second predetermined threshold, comparing, by one or more processors, usage of the mobile device with one or more existing analytics models using a set of analytic techniques that describe a first behavior of a regular user with a second behavior of a suspect user stored as part of said historical information;
in response to determining the usage of the mobile device matches a behavior associated with an existing criminal model stored as part of said historical information, incrementing, by one or more processors, the threat level associated with the mobile device by a second predetermined amount;
in response to determining the threat level associated with the mobile device exceeds a third predetermined threshold, using a set of cognitive techniques to further assess, by one or more processor, potential behavior of a user based on data collected from said mobile device;
in response to determining an analysis of said data collected from the usage of the mobile device is indicative of a potential attempt to commit a predetermined negative action, incrementing, by one or more processors, the threat level associated with the mobile device by a third predetermined amount; and
in response to determining the threat level associated with the mobile device exceeds a fourth predetermined threshold, initiating, by one or more processors, a predefined action linked to said mobile device intended to prevent said predetermined negative action.

2. The method as recited in claim 1,
wherein said predefined action includes sending an alert to appropriate security personnel.

3. The method as recited in claim 1,
wherein said predefined action includes blocking a call placed on said mobile device.

4. The method as recited in claim 1,
wherein said threat level is measured by a tally of points assessed by said predictive model, said tally of points used to determine said predetermined thresholds associated with said threat level.

5. The method as recited in claim 1,
wherein said first predetermined amount is a predetermined number of points, said second predetermined amount is a second predetermined number of points, said third predetermined amount is a third predetermined number of points.

6. The method as recited in claim 1,
wherein the length of time and the first predetermined amount is recalculated on a configurable schedule to recalibrate a management system in response to new data being processed.

7. The method as recited in claim 1,
wherein the existing models contain attributes including an average number of calls, one or more distinct destination numbers, a call duration, geographic information of one or more target numbers.

8. The method as recited in claim 1,
wherein the existing models are recalibrated in the management system to continuously learn from behaviors.

9. The method as recited in claim 1, further comprising:
wherein said cognitive techniques include advanced algorithms including recording of calls, voice recognition, speech-to-text transformation of the calls, sentiment analysis of text to identify a criminal or a malicious intent, analysis of content transmitted via Internet and special messages to further describe behavior of a user.

10. A computer program product comprising:
a computer-readable storage device; and
a computer-readable program code stored in the computer-readable storage device, the computer readable program code containing instructions executable by a processor of a computer system to implement a method for managing mobile device usage, the method comprising:
in response to determining a mobile device has entered a predetermined area comprising a geo-location, determining a length of time the mobile device remains in the predetermined area;
in response to determining the length of time exceeds a first predetermined threshold, incrementing a threat level associated with the mobile device by a first predetermined amount, wherein the predetermined amount is calculated using a predictive model created with historical information derived from a management system for a telecom network,
in response to determining the threat level associated with the mobile device exceeds a second predetermined threshold, comparing usage of the mobile device with one or more existing models that describe a behavior of a regular user and the behavior of a suspect user;
in response to determining the usage of the mobile device matches a behavior associated with an existing criminal model, incrementing the threat level associated with the mobile device by a second predetermined amount;
in response to determining the threat level associated with the mobile device exceeds a third predetermined threshold, using a set of cognitive techniques to further assess potential behavior of a user;
in response to determining an analysis of data collected from the usage of the mobile device is indicative of a potential attempt to commit a predetermined negative action, incrementing the threat level associated with the mobile device by a third predetermined amount; and
in response to determining the threat level associated with the mobile device exceeds a fourth predetermined threshold, initiating a predefined action intended to prevent said predetermined negative action.

11. The computer program product as recited in claim 10, wherein said predefined action includes at least one of sending an alert to appropriate personnel and blocking a call made on said mobile device.

12. The computer program product as recited in claim 10, further comprising
said threat level is measured by a tally of points assessed by said predictive model.

13. The computer program product as recited in claim 10, wherein said first predetermined amount is a predetermined number of points, said second predetermined amount is a second predetermined number of points, said third predetermined amount is a third predetermined number of points.

14. The computer program product as recited in claim 10, wherein
the length of time and the first predetermined amount is recalculated on a configurable schedule to recalibrate a management system in response to new data being processed.

15. The computer program product as recited in claim 10, wherein the existing models contain attributes including an average number of calls, one or more distinct destination numbers, a call duration, geographic information of one or more target numbers.

16. The computer program product as recited in claim 10, wherein the existing models are recalibrated in the management system to continuously learn from behaviors.

17. The computer program product as recited in claim 10, wherein said cognitive techniques include advanced algorithms including recording of calls, voice recognition, speech-to-text transformation of the calls, sentiment analysis of text to identify a criminal or a malicious intent, analysis of content transmitted via Internet and special messages to further describe behavior of a user.

18. A computer system comprising:
a processor;
a memory coupled to said processor; and
a computer readable storage device coupled to the processor, the storage device containing instructions executable by the processor via the memory to implement a method for managing mobile device usage, the method comprising:
in response to determining a mobile device has entered a predetermined area comprising a geo-location, determining a length of time the mobile device remains in the predetermined area;
in response to determining the length of time exceeds a first predetermined threshold, incrementing a threat level associated with the mobile device by a first predetermined amount, wherein the predetermined amount is calculated using a predictive model created with historical information derived from a management system for a telecom network,
in response to determining the threat level associated with the mobile device exceeds a second predetermined threshold, comparing usage of the mobile device with one or more existing models that describe a behavior of a regular user and the behavior of a suspect user;
in response to determining the usage of the mobile device matches a behavior associated with an existing criminal model, incrementing the threat level associated with the mobile device by a second predetermined amount;
in response to determining the threat level associated with the mobile device exceeds a third predetermined threshold, using a set of cognitive techniques to further assess potential behavior of a user;
in response to determining an analysis of data collected from the usage of the mobile device is indicative of a potential attempt to commit a predetermined negative action, incrementing the threat level associated with the mobile device by a third predetermined amount; and
in response to determining the threat level associated with the mobile device exceeds a fourth predetermined threshold, initiating a predefined action intended to prevent said predetermined negative action.

19. The computer system as recited in claim 18, wherein the length of time and the first predetermined amount is recalculated on a configurable schedule to recalibrate a management system in response to new data being processed.

20. The computer system as recited in claims 18, wherein the existing models are recalibrated in the management system to continuously learn from behaviors.
